(19) United States
(12) Patent Application Publication
(10) Pub. No.: US 2009/0032362 A1
(43) Pub. Date: Feb. 5, 2009

(54) WRAP SPRING CLUTCH

(76) Inventors: Falk Nickel, Fuchstal (DE); Johann Oswald, Eschenlohe (DE); Jurgen Ackermann, Waal (DE); Tilo Sielaff, Peiting (DE)

Correspondence Address: MICHAEL BEST & FRIEDRICH LLP, 100 E WISCONSIN AVENUE, Suite 3300, MILWAUKEE, WI, 53202, US

(21) Appl. No.: 12/182,244

(22) Filed: Jul. 30, 2008

(30) Foreign Application Priority Data
Jul. 30, 2007 (EP) 07014940.6

(51) Int. Cl. F16D 13/72

(52) U.S. Cl. 192/113.3

(57) ABSTRACT

A wrap spring clutch according to some embodiments has a center shaft; a wrap spring wrapped around the center shaft in a direction of winding, and having two wrap spring ends and an abutting surface for co-operation with a friction surface; and a hollow shaft positioned around the wrap spring; and a cooling device positioned adjacent the friction surface.

### CROSS-REFERENCE TO RELATED APPLICATIONS

Priority is hereby claimed to European Patent Application No. 07014940.6, filed on Jul. 30, 2007, the entire contents of which are incorporated herein by reference.

### BACKGROUND

The present invention relates to a wrap spring clutch.

In the course of automation and electronic control of drives for machines and vehicles, the importance of clutches having corresponding properties has increased. The essential requirements include a high variability of torque, short reaction times, small construction space, low effort and low energy demand of the clutch actuator, high reliability and a behaviour as constant as possible during the complete life cycle. Currently, mainly lamella clutches having different actuator systems are used. They may be of an electrical, electro-hydraulic, pneumatic or mechanic type, or may be embodied with a MRF/ERF. In known systems, efforts are being made toward meeting increasing requirements of torque for the torque transmitting part(s) as well as actuator systems. Integration of the systems becomes more difficult, and causes costs to increase.

A wrap spring clutch disclosed in U.S. Pat. No. 4,250,984 has been up to now only used as a passive member (e.g., as a torque limiter) or as an active member in constructions only having an on/off function. For its use as a dry high performance clutch controlled operation, no sufficient cooling is available.

It is therefore an object underlying the present invention to provide a wrap spring clutch that enables effective cooling for use in dry running operation.

### SUMMARY

In some embodiments of a wrap spring clutch according to the present invention, the friction surface is, contrary to a lamella clutch, not disposed on a plurality of individual discs, but is arranged on a compact cylinder, wherein the friction surface is located on the inside or outside, depending on the system. A water cooling device may easily be integrated into the cylinder, which may be either a central inner shaft or a hollow shaft enclosing the wrap spring from the outside.

For this purpose, longitudinal bores may be provided, through which a cooling medium such as cooling water may flow. Generated friction heat is discharged from the friction surface in the vicinity of which the cooling device is arranged, transmitted through heat conducts, and passed to the cooling medium.

In case of an intrinsic wrap spring clutch, it is possible to provide an outer hollow shaft having a double wall casing rather than longitudinal bores, for example. Cooling water may then be pumped through a space between the inner wall of the outer hollow shaft, which comprises the friction surface on its inside, and the outer wall of the outer hollow shaft.

Water-cooled wrap spring clutches according to some embodiments of the present invention are particularly advantageous in view of environment protection, since it is possible to completely dispense with the use of non-water lubricants as cooling mediums, thus preventing the release of water damaging materials. Simultaneously, however, it is possible to increase the performance of the inventive clutch, even in case of increasing design requirements concerning the transmission members in the drive train of a vehicle, since sufficient cooling is secured. The inventive wrap spring clutches according to the present invention are particularly well suited for controlled operations in which an actuator applying a controlled tangential force acts on at least one of the wrap spring ends opposite their winding direction. Further, the advantage of a functional separation between the cooling medium and a tribologic system is obtained, which means that the frictional contact may preferably be dry, or that oil may be supplied merely for frictional properties.

Some embodiments of the present invention provide a wrap spring clutch comprising a center shaft; a wrap spring wrapped around the center shaft in a direction of winding, and comprising two wrap spring ends and an abutting surface for co-operation with a friction surface; and a hollow shaft positioned around the wrap spring; and a cooling device positioned adjacent the friction surface.

Other aspects of the present invention will become apparent by consideration of the detailed description and accompanying drawings.

### BRIEF DESCRIPTION OF THE DRAWINGS

FIG. 1 shows a schematic front view of one possible structure of a wrap spring clutch.

FIG. 2 shows a schematic front view of a wrap spring clutch according to an embodiment of the present invention.

FIG. 3 shows a schematic sectional view of the wrap spring clutch in FIG. 2.

### DETAILED DESCRIPTION

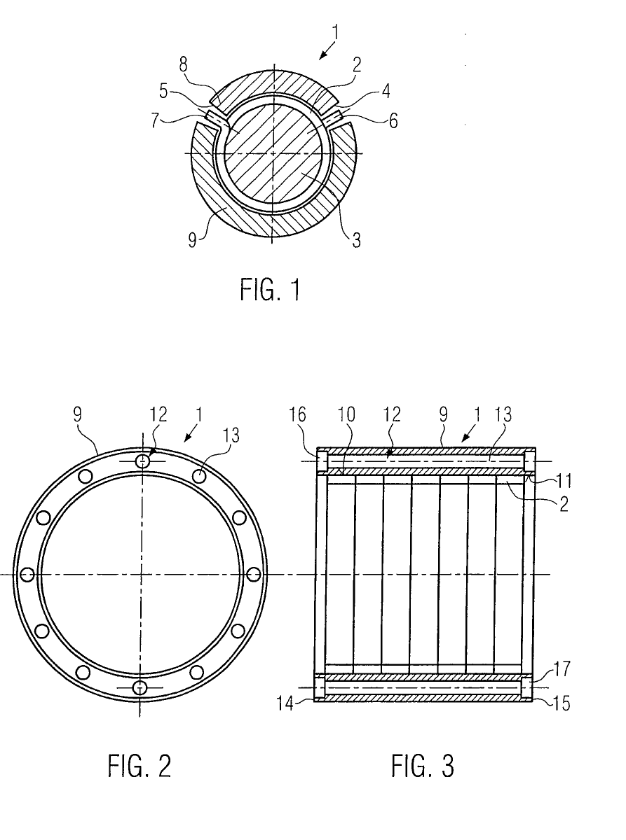

For the purpose of illustrating a possible structure of a wrap spring clutch 1 according to the present invention, FIG. 1 shows a wrap spring 2, which is arranged on a center shaft 3 in a biased state. Depending on the direction of rotation, a segment 8 of a driving part engages two spring ends 6 and 7 protruding in or through recesses 4 and 5. When a load is applied at the output, a rotation occurs by form-fit through the respective spring end 6 or 7 and a hollow shaft 9. When a torque occurs at the output which intends to surpass the input, the segment 8 blocks through the respective spring member 6 or 7 of the wrap spring 2.

This system involves minimal play between the flanges of the segment 8 and the hollow shaft 9 and the spring ends 6 and 7, and is not dependent on the direction of rotation. The direction of winding of the wrap spring 2 also has no influence on the function.

Rather than have a center shaft 3, a corresponding structure in a sleeve of a housing (not shown in detail in FIG. 1) may be provided. The ends 6 and 7 of the wrap spring 2 will then accordingly be bent inwardly.

According to FIG. 2, a front view of the hollow shaft 9 being arranged around the wrap spring 2 is shown, which details the provision of a cooling device 12 comprising a plurality of longitudinal bores in the embodiment shown in FIGS. 2 and 3, one of which is designated with reference numeral 13 as an example. In this example, twelve of these longitudinal bores are provided, and extend along the complete length of the hollow shaft 9, as shown in FIG. 3. Annular grooves 16, 17 are shown in this embodiment in the two opposite face sides 14 and 15, said grooves forming an inlet groove and an outlet groove for cooling water, and being covered by a cover (not shown in the figures) in an operating state.

As results from the illustration of FIG. 3 in which the wrap spring 2, but not the center shaft 3 is shown, the wrap spring in this example comprises an abutting surface 10 disposed at the outside thereof, said abutting surface cooperating with an inwardly facing friction surface 11 of the hollow shaft 9. In this regard, it is discernible from FIG. 3 that the cooling device 12 is provided adjacent the friction surface 11, such that heat generated by the friction process may be discharged by means of water of the cooling device 12 in a simple and reliable manner.

Various features and advantages of the invention are set forth in the following claims.

What is claimed is:

1. A wrap spring clutch comprising:
a center shaft;
a wrap spring wrapped around the center shaft in a direction of winding, and comprising two wrap spring ends and an abutting surface for co-operation with a friction surface;
a hollow shaft positioned around the wrap spring; and
a cooling device positioned adjacent the friction surface.

2. The wrap spring clutch of claim 1, wherein the cooling device extends within the center shaft.

3. The wrap spring clutch of claim 1, wherein the cooling device is located in the hollow shaft.

4. The wrap spring clutch of claim 1, wherein the cooling device has longitudinal shaft bores though which a cooling medium is passed.

5. The wrap spring clutch of claim 1, wherein the cooling device is defined at least in part by a double wall shaft casing.

6. The wrap spring clutch of claim 3, wherein the cooling device comprises at least one of an annular cooling medium inlet groove and an annular cooling medium outlet groove defined in a corresponding shaft face.

7. The wrap spring clutch of claim 6, wherein at least one of the grooves is closed by a respective cover.

8. The wrap spring clutch of claim 2, wherein the cooling device has longitudinal shaft bores though which a cooling medium is passed.

9. The wrap spring clutch of claim 3, wherein the cooling device has longitudinal shaft bores though which a cooling medium is passed.

10. The wrap spring clutch of claim 2, wherein the cooling device is defined at least in part by a double wall shaft casing.

11. The wrap spring clutch of claim 3, wherein the cooling device is defined at least in part by a double wall shaft casing.

12. The wrap spring clutch of claim 4, wherein the cooling device comprises at least one of an annular cooling medium inlet groove and an annular cooling medium outlet groove defined in a corresponding shaft face.

13. The wrap spring clutch of claim 8, wherein the cooling device comprises at least one of an annular cooling medium inlet groove and an annular cooling medium outlet groove defined in a corresponding shaft face.

14. The wrap spring clutch of claim 9, wherein the cooling device comprises at least one of an annular cooling medium inlet groove and an annular cooling medium outlet groove defined in a corresponding shaft face.

15. The wrap spring clutch of claim 12, wherein at least one of the grooves is closed by a respective cover.

16. The wrap spring clutch of claim 13, wherein at least one of the grooves is closed by a respective cover.

17. The wrap spring clutch of claim 14, wherein at least one of the grooves is closed by a respective cover.
